(19) United States
(12) Patent Application Publication
(10) Pub. No.: US 2014/0204923 A1
(43) Pub. Date: Jul. 24, 2014

(54) Method and Arrangement in a Wireless Communication System

(71) Applicants: Vicknesan Ayadurai, Sollentuna (SE); Mikael Prytz, Ronninge (SE)

(72) Inventors: Vicknesan Ayadurai, Sollentuna (SE); Mikael Prytz, Ronninge (SE)

(73) Assignee: TELEFONAKTIEBOLAGET L M ERICSSON (PUBL), Stockholm (SE)

(21) Appl. No.: 14/125,986

(22) PCT Filed: Jun. 17, 2011
(86) PCT No.: PCT/SE2011/050771

§ 371 Date: Dec. 13, 2013

(51) Int. Cl. H04W 72/04; H04W 88/10; H04B 7/26

(52) U.S. Cl. CPC H04W 72/048; H04B 7/2653; H04W 88/10
USPC 370/337; 455/452.1; 455/561

(57) ABSTRACT

A radio network node for handling data streams from a user equipment is provided. The radio network node comprises a first receiving interface and a second receiving interface. The radio network node creates (201) a representation of a first data stream. The first data stream is received via the first receiving interface. The radio network node further creates (202) a representation of a second data stream. The second data stream is received via the second receiving interface. The radio network node then compares (203) the representation of the first data stream with the representation of the second data stream. When the representation of the first data stream is equal to the representation of the second data stream, the radio network node identifies (204) that the first data stream received via the first receiving interface and the second data stream received via the second receiving interface are identical data streams received via different sources of transmission.

### TECHNICAL FIELD

Embodiments herein relate to a radio network node and a method therein. In particular, it relates to handling data streams from a user equipment.

### BACKGROUND

Communication devices such as mobile stations are also known as e.g. mobile terminals, wireless terminals and/or user equipments (UE). Mobile stations are enabled to communicate wirelessly in a cellular communications network or wireless communication system, sometimes also referred to as a cellular radio system. The communication may be performed e.g. between two mobile stations, between a mobile station and a regular telephone and/or between a mobile station and a server via a Radio Access Network (RAN) and possibly one or more core networks, comprised within the cellular communications network.

Mobile stations may further be referred to as mobile telephones, cellular telephones, or laptops with wireless capability, just to mention some further examples. The mobile stations in the present context may be, for example, portable, pocket-storable, hand-held, computer-comprised, or vehicle-mounted mobile devices, enabled to communicate voice and/or data, via the radio access network, with another entity, such as another mobile station or a server.

The cellular communications network covers a geographical area which is divided into cell areas, wherein each cell area being served by a base station, e.g. a Radio Base Station (RBS), which sometimes may be referred to as e.g. “eNB”, “eNodeB”, “NodeB”, “B node”, or BTS (Base Transceiver Station), depending on the technology and terminology used. The base stations may be of different classes such as e.g. macro eNodeB, home eNodeB or pico base station, based on transmission power and thereby also cell size. A cell is the geographical area where radio coverage is provided by the base station at a base station site. One base station, situated on the base station site, may serve one or several cells. Further, each base station may support one or several communication technologies. The base stations communicate over the air interface operating on radio frequencies with the mobile stations within range of the base stations.

In some radio access networks, several base stations may be connected, e.g. by landlines or microwave, to a radio network controller, e.g. a Radio Network Controller (RNC) in Universal Mobile Telecommunications System (UMTS), and/or to each other. The radio network controller, also sometimes termed a Base Station Controller (BSC) e.g. in GSM, may supervise and coordinate various activities of the plural base stations connected thereto. GSM is an abbreviation for Global System for Mobile Communications (originally: Groupe Special Mobile).

In 3rd Generation Partnership Project (3GPP) Long Term Evolution (LTE), base stations, which may be referred to as eNodeBs or even eNBs, may be directly connected to one or more core networks.

UMTS is a third generation mobile communication system, which evolved from the GSM, and is intended to provide improved mobile communication services based on Wideband Code Division Multiple Access (WCDMA) access technology. UMTS Terrestrial Radio Access Network (UTRAN) is essentially a radio access network using wideband code division multiple access for mobile stations, The 3GPP has undertaken to evolve further the UTRAN and GSM based radio access network technologies.

According to 3GPP/GERAN, a mobile station has a multi-slot class, which determines the maximum transfer rate in the uplink and downlink direction. GERAN is an abbreviation for GSM EDGE Radio Access Network. EDGE is further an abbreviation for Enhanced Data rates for GSM Evolution.

In the context of this disclosure, the expression DownLink (DL) is used for the transmission path from the base station to the mobile station. The expression UpLink (UL) is used for the transmission path in the opposite direction i.e. from the mobile station to the base station.

Many wireless communications systems rely on an infrastructure-based design, deployment, and mode of access to efficiently support the services that they provide. This is particularly if mobility, wide-area availability, and wide-area connectivity are essential for the service, such as telephony, Internet access, and Mobile Broad Band. In such designs wireless devices from now on referred to as user equipments, typically always connect to the infrastructure via base stations, access points and other network nodes, which manages the availability, mobility, and connectivity functions. All communication between user equipments passes through the infrastructure.

Future communications systems will likely need to handle many more user equipments, more densely clustered user equipments, more types of services and communication patterns, and much greater data volumes and throughput requirements. User equipments will likely also still have capabilities to operate with several communications systems due to systems evolving, market structures and market differences, niche applications, etc.

A user equipment in a communications system typically receives information via a specified link or interface, i.e., a primary receiving interface, such as a LTE interface However, the user equipment may potentially have other interfaces or means present, such as e.g. a WiFi interface, which may be able to overhear this identical information via alternative independent links. The two or more independent links or interfaces, may for example also be two or more independent radio channels of GSM.

In some scenarios, for example in wireless systems, it is beneficial for the receiving user equipment to combine the information received via these two or more independent radio channels, to produce a more accurate representation of the original message. What needs to be verified is that information to be combined is different representations of the same source transmission.

Given the device and traffic evolution described above, future communications systems will likely have several orders of magnitude larger capacity requirements compared to today. At the same time the evolution may also increase the likelihood of communications between devices that are close to each other. Existing infrastructure-based solutions typically do not treat the local communications differently from other communications.

Without being explicitly told, it is difficult for a user equipment to deduce if the information it receives on its alternative, i.e., non-primary receiving interfaces is meant for it. This would require decoding the different incoming information, and subsequently carrying out a bitwise comparison of what was received on the different interfaces, to verify if this is indeed the case.

Additionally, the information from the various interfaces could potentially arrive at different instances in time. Thus, the node would have to store older information blocks, so they could be examined at a later stage. This means of verification is time and memory consuming, as well as a computationally tedious process.

Another problem would be the potential exposure of information overheard, but not actually intended for this receiving node, which may have security implications.

### SUMMARY

It is therefore an object of embodiments herein to provide a way of improving the performance of a wireless communications system.

According to a first aspect of embodiments herein, the object is achieved by a method in a radio network node for handling data streams from a user equipment. The radio network node comprises a first receiving interface and a second receiving interface. The radio network node creates a representation of a first data stream. The first data stream is received via the first receiving interface.

The radio network node further creates a representation of a second data stream. The second data stream is received via the second receiving interface.

The radio network node then compares the representation of the first data stream with the representation of the second data stream.

When the representation of the first data stream is equal to the representation of the second data stream, the radio network node identifies that the first data stream received via the first receiving interface and the second data stream received via the second receiving interface are identical data streams received via different sources of transmission.

According to a second aspect of embodiments herein, the object is achieved by a radio network node for handling data streams from a user equipment. The radio network node comprises a first receiving interface and a second receiving interface. The radio network node further comprises a creating unit configured to create a representation of a first data stream, which data stream is received via the first receiving interface, and further configured to create a representation of a second data stream, which data stream is received via the second receiving interface.

The radio network node further comprises a processing unit configured to compare the representation of the first data stream with the representation of the second data stream. The processing unit further is configured to identify that the first data stream received via the first receiving interface and the second data stream received via the second receiving interface are identical data streams received via different sources of transmission, when the representation of the first data stream is equal to the representation of the second data stream.

Since the radio network node creates a respective representation of the first second data stream and compares the representations of the first and second data stream, and since the radio network node identifies that the first data stream and the second data stream are identical data streams received via different sources of transmission, when the representation of the first data stream is equal to the representation of the second data stream, the network node may take steps to reduce the load on the base station or network node, and thereby improve the performance of the overall wireless communication system.

### BRIEF DESCRIPTION OF THE DRAWINGS

Examples of embodiments herein are described in more detail with reference to attached drawings in which:

FIG. 1 is a schematic block diagram illustrating embodiments in a wireless communications system.

FIG. 2 is a flowchart depicting embodiments of a method in a radio network node.

FIG. 3 is a schematic block diagram illustrating embodiments in a wireless communications system.

FIG. 4 is a schematic block diagram illustrating embodiments in a wireless communications system.

FIG. 5 is a schematic block diagram illustrating embodiments in a wireless communications system.

FIG. 6 is a schematic block diagram illustrating embodiments in a wireless communications system.

FIG. 7 is a flowchart depicting embodiments of a method in a radio network node.

FIG. 8 is a schematic block diagram illustrating embodiments of a radio network node.

### DETAILED DESCRIPTION

Embodiments will be exemplified in the following non-limiting description.

According to embodiments herein, a wireless device such as a user equipment establishes that it can receive a communication stream of packets from multiple sources of transmission, which e.g. enables it to autonomously act to improve overall system performance such as transmission time, energy usage/power levels, transmission quality, etc.

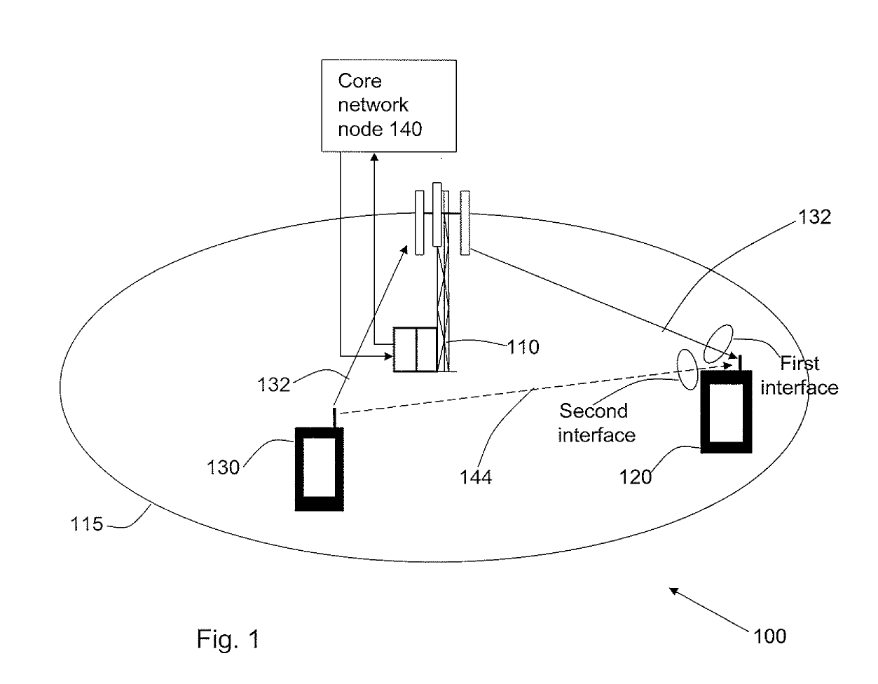

FIG. 1 depicts a wireless communications system 100 in which embodiments herein may be implemented. The wireless communications system 100 is a cellular communication network such as an LTE, WCDMA, GSM network, any 3GPP cellular network, or any cellular network or system.

The wireless communications system 100 comprises a base station 110 which in some figures is referred to as BS. The base station 110 is a radio base station serving a cell 115. The base station 110 is a radio network node which in this example e.g. may be an eNB, eNodeB, or a Home Node B, a Home eNode B or any other network unit capable to serve a user equipment or a machine type communication device in a wireless communications system. The base station 110 is a radio network node and is in some embodiments referred to as a radio network node.

A user equipment 120 is located within the cell 115. The user equipment 120 is in some figures is referred to as UE 120, and is configured to communicate within the wireless communications system 100 via the base station 110 over a radio link when the user equipment 120 is present in the cell 115 served by the base station 110. The user equipment 120 is also a radio network node and is in some embodiments referred to as a radio network node. According to embodiments herein the user equipment 120 may comprise a first receiving interface and a second receiving interface. The receiving interfaces may e.g. be channel resources.

The user equipment 120 is arranged to receive a data stream from a user equipment 130 via the base station 110, a transmission from the first user equipment 120 via the base station 110 to the user equipment 130 is referred to as 132 in FIG. 1. The transmitting user equipment is in some figures is referred to as UE 130. The data stream may possibly be received via further intermediate nodes such another base station (not shown) serving the user equipment 130 when being located in another cell than the user equipment 120 and/or such as a core network node 140. According to embodiments herein also the base station 110 may comprise a first receiving interface and a second receiving interface.

Some embodiments herein may be implemented both in the base station 110 and the user equipment 120 or any other radio network node. In these embodiments, the term radio network node 110, 120 is used to cover all these nodes.

The user equipment 120 may in some embodiments be arranged to receive the data stream from the user equipment 130 directly, i.e. not via any base station or intermediate node, this direct connection is referred to as 144 in FIG. 1. This may be in a peer to peer connection or a device to device connection.

The user equipment 120 and the user equipment 130 may e.g. be mobile terminals or wireless terminals, mobile phones, computers such as e.g. a laptop, Personal Digital Assistant (PDA) or tablet computers, sometimes referred to as surf plates, with wireless capability, or any other radio network unit capable to communicate over a radio link in a wireless communications system.

The idea assumes that the receiving node may be able to hear the original transmission via some alternative resource(s). This means it would understand modulation, code-rates, encryption schemes if present, etc.

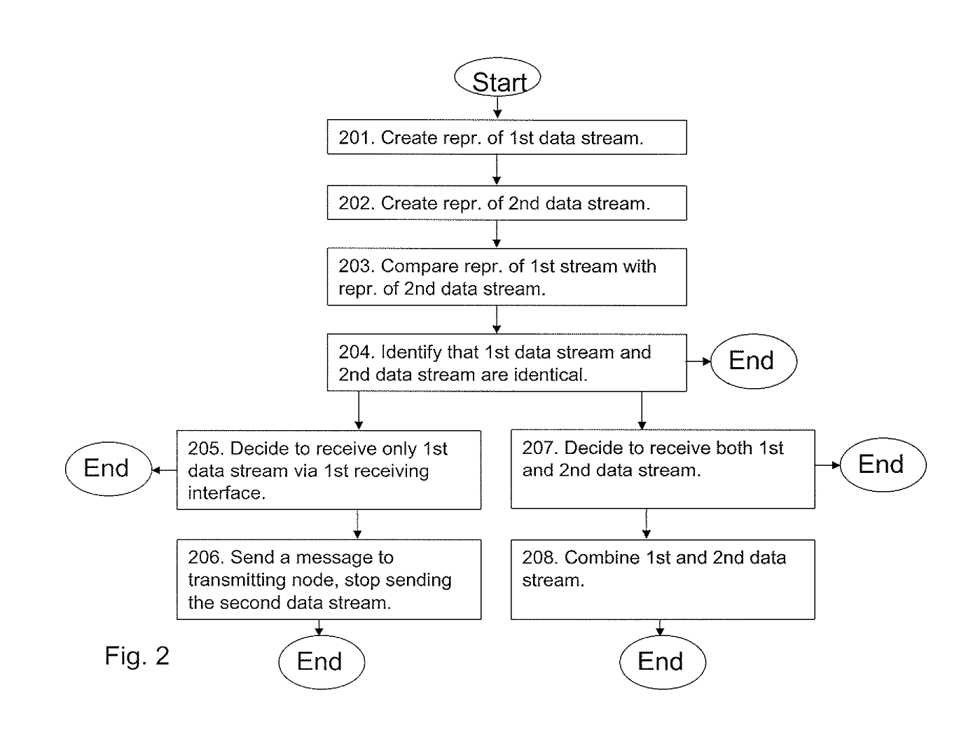

Embodiments of a method in a radio network node when being a user equipment 120 for handling data streams from the user equipment 130 will now be described with reference to the flowchart depicted in FIG. 2. As mentioned above, the user equipment 120 comprises a first receiving interface and a second receiving interface. The user equipment 120 may also comprise further receiving interfaces, even if the examples herein only describe the first receiving interface and the second receiving interface.

Independently the user equipment 120 listens to one or more other receiving interfaces also referred to as channel resources, on the same wireless communications system 100 and/or on one or more channels resources on one or more different wireless communications systems.

In some embodiments the first receiving interface and the second receiving interface are wireless interfaces of the same system. This may be interfaces of systems of any of the wireless receiving interfaces of TDMA, WCDMA, LTE, Bluetooth, Wireless Local Area Network (WLAN), infrared, WiFi, device-to-device, peer-to-peer, Frequency Division Multiple Access (FDMA), Universal Mobile Telecommunications System (UMTS), High Speed Packet Access (HSPA) of Wideband Code Division Multiple Access (WCDMA), or Global System for Mobile communications (GSM).

The first receiving interface may e.g. be one or more first slots in a TDMA frame, and the second receiving interface may e.g. be an allocated slot in the TDMA frame. The user equipment 120 then listens on both the one or more first slots and the allocated slot. This will be described more in detail below.

In some embodiments, the first receiving interface is one or more first physical resource blocks in a LTE frame, and the second receiving interface is an allocated physical resource block in a LTE frame. The user equipment 120 then listens on both the one or more first physical resource block and the allocated physical resource block.

In some embodiments, the user equipment 120 operates with one or more wireless communications systems. The user equipment 120 comprises information of, or is able to deduce, the reception parameters and algorithms that are needed to decode any packets arriving on the other channel resources it listens to.

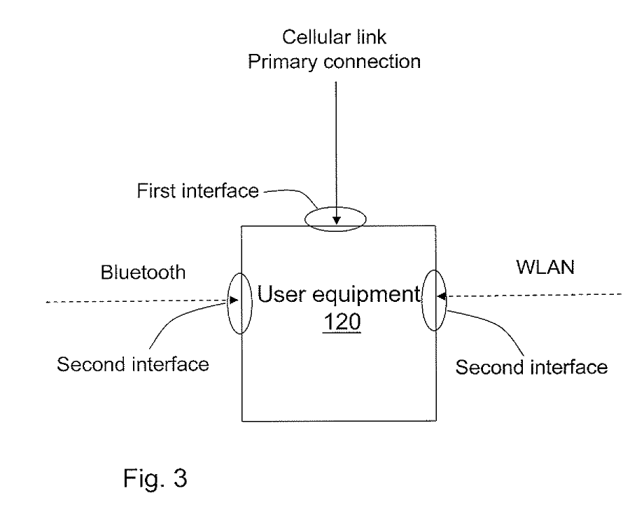

In some embodiments the first receiving interface and the second receiving interface and possibly further receiving interfaces are wireless interfaces of different systems. The different wireless interfaces may be any of the receiving interfaces of TDMA, WCDMA, LTE, Bluetooth, WLAN, infrared, WIFi, device-to-device, peer-to-peer FDMA, UMTS, HSPA of WCDMA, or GSM. One example of these embodiments is depicted in FIG. 3. In this example the user equipment 120 comprises three receiving interfaces, the first receiving interface being a cellular link which in this case is a primary connection. The user equipment 120 further comprises the second receiving interface being a Bluetooth interface and a further interface being a WLAN interface. The computations below may take place independently of whether or not information is arriving on the primary interface, and may comprise information directed to the user equipment 120 as well as information destined for other nodes.

Referring again to FIG. 2, the method comprises the following actions, which actions may as well be carried out in another suitable order than described below.

Action 201

The user equipment 120 creates a representation of a first data stream. The data stream is received via the first receiving interface. The representation of the first data stream is in some embodiments a unique representation, and may be referred to as a compact representation of the first data stream.

This action may be performed by computing the first data stream or part of it with a mathematical operation to obtain the representation of the first data stream. The mathematical operation is such that it has a property that for any arbitrarily long string of information, a unique shorter representation is created, such as e.g. a cyclic-redundancy check, check-sums, or a one-way hash function. E.g. a 32-bit Cyclic-Redundancy Check (CRC) or 64-bit CRC, henceforth CRC32, or CRC64 may be used to compute on the received first data stream or part of it. E.g. checksums such as sum16, or sum32. One-way hash functions such as e.g., MD5, SHA-256, or similar may be used. The operation may be performed on a per-packet basis or on parts of the packet, e.g., the payload The identifying that the first data stream received via the first receiving interface and the second data stream received via the second receiving interface are identical data streams received via different sources of transmission to be performed in Action 204 may be improved. This may be achieved by performing the creation of the representation of the first data stream periodically, e.g. such that consecutive data packets are computed periodically. E.g. to improve on the matching estimate, a few consecutive packets of the stream may be compared, instead of just a single packet, since the mathematical function may incorrectly provide a ‘match’ outcome, even though the original packets do not match. If more then this ‘threshold value’ of consecutive packets is matched, then it may be considered that the streams identical. The higher the threshold value set at, the more certain a guess of a match will be.

In some embodiments, the one or more representations of the first data stream is stored, e.g. in a memory such as in a table in a memory.

Action 202

The user equipment 120 creates a representation of a second data stream. The data stream is received via the second receiving interface. The representation of the second data stream is in some embodiments a unique representation, and may be referred to as a compact representation of the second data stream.

This action may also be performed by computing at least a part of the second data stream with the mathematical operation to obtain the representation of the second data stream. As in the action above, the mathematical operation is such that it has a property that for any arbitrarily long string of information, a unique shorter representation is created. The operation may be performed on a per-packet basis or on parts of the packet, e.g., the payload.

The mathematical operation may e.g. be a cyclic-redundancy check, check-sums, or a one-way hash function. E.g. a 32-bit Cyclic-Redundancy Check (CRC) or 64-bit CRC, henceforth CRC32, or CRC64 may be used to compute on the received second data stream or part of it. E.g. checksums such as sum16, or sum32. One-way hash functions such as e.g., MD5, SHA-256, or similar may be used.

As mentioned above, the identifying that the first data stream received via the first receiving interface and the second data stream received via the second receiving interface are identical data streams received via different sources of transmission to be performed in Action 204 may be improved. This may be achieved by performing the creation of the representation of the second data stream periodically, e.g. such that consecutive data packets are computed periodically. E.g. to improve on the matching estimate, a few consecutive packets of the stream may be compared, instead of just a single packet, since the mathematical function may incorrectly provide a match outcome, even though the original packets do not match. If more than this threshold value of consecutive packets is matched, then it may be considered that the streams are identical. The higher the threshold value set to, the more certain a match will be.

In some embodiments, the one or more representation of the second data stream is also stored e.g. in a memory such as in a in the table in the memory.

Action 203

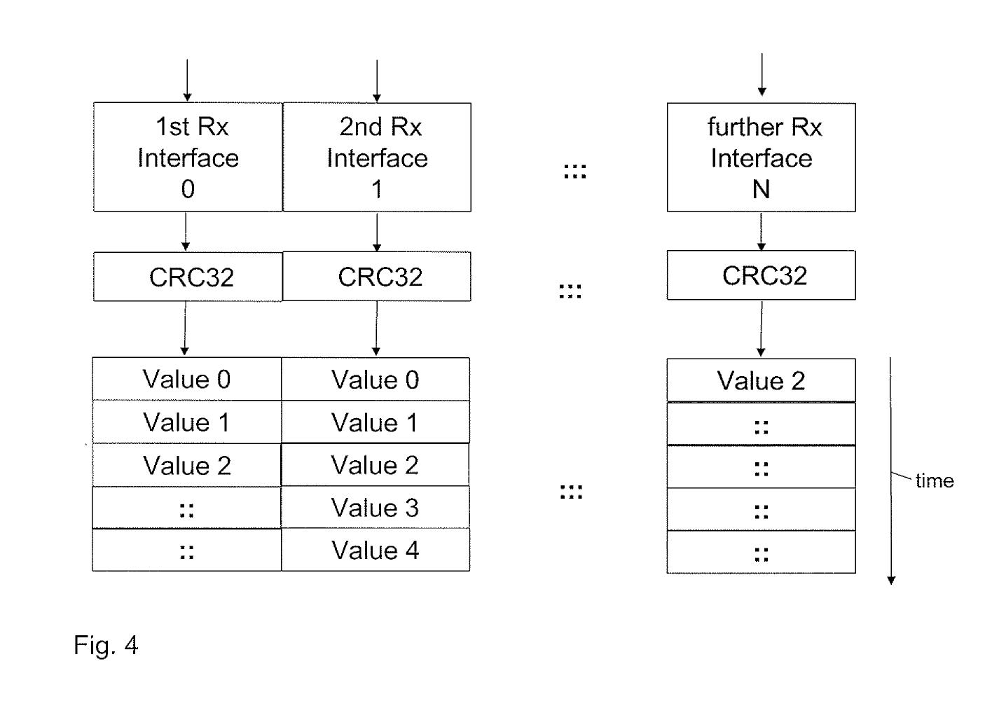

The user equipment 120 then compares the representation of the first data stream with the representation of the second data stream. In the embodiments wherein the representations of the data streams have been stored in the table, this action may be performed by comparing the representation of the first data stream with the contents of the table, comprising the representation of the second data stream, or the representation of the first data stream and the representation of the second data stream. FIG. 4 below shows an embodiment of the table whereby CRC32 values are automatically computed in hardware, as information is overheard on the various receiver interfaces comprised in the user equipment 120. Computed CRC32 values are stored in a table for future lookups.

The receiving interfaces referred to as Rx interface in this figure may e.g. refer to different timeslots in a TDMA frame, or to the different types of interfaces such as cellular, WLAN, Bluetooth etc. as specified in the second example.

The user equipment 120 may use a matching scheme e.g. periodically, to compare the stored representations of the data streams. An aim of the matching scheme may be to find out if the data stream that is received via the first receiving interface is also received at one or more of the other channel resources such as the second receiving interface that the user equipment listens to. The matching scheme may require that one or more consecutively received representations of the data streams match. The scheme may consider time-translated matching, i.e., checking whether a data stream has been received earlier, or possibly later, on one of the other receiving interfaces.

Action 204

When the representation of the first data stream is equal to the representation of the second data stream, the user equipment 120 identifies that the first data stream received via the first receiving interface and the second data stream received via the second receiving interface are identical data streams received via different sources of transmission. This enables the user equipment 120 to detect parallel identical packet streams, and subsequently use this information for various purposes.

In some embodiments the identifying that the first data stream and the second data stream are identical data streams received via different sources of transmission is verified when exceeding a threshold value of a number of consecutive representations of the first data stream being equal to a number of consecutive representations of the second data stream. It is verified when a threshold number of consecutive matches has been identified. So, e.g. as mentioned above, to improve on the matching estimate, a few consecutive packets of the stream may be compared, instead of just a single packet, since the mathematical function may incorrectly provide a match outcome, even though the original packets do not match. If more then this threshold value of consecutive packets is matched, then it may be considered that the streams identical. The higher the threshold value set at, the more certain a match will be.

Action 205 The user equipment 120 may decide to receive the first data stream via the first receiving interface but not the second data stream via the second receiving interface.

This may be for example be decided in a scenario where the first data stream of the first receiving interface is received from the user equipment 130 without any intermediate nodes, and where the second data stream of the second receiving interface is received from the user equipment 130 via intermediate nodes, such as e.g. the base station 110, another base station serving the user equipment 130 when being located in another cell than the user equipment 120 and/or such as the core network node 140.

This decision may also for example be based on that the receiving of the first data stream on the first receiving interface requires less energy and/or creates less interference, and/or uses fewer system resources than the receiving of the second data stream on the second receiving interface.

Action 206

In some embodiments the user equipment 120 sends to the node transmitting to the second receiving interface, a message to stop transmitting the second data stream to the second receiving interface. In this embodiment the node transmitting to the second receiving interface is the base station 110. In this way the base station 110 will be informed to stop the second transmission, which will off load the base station and free up radio resources such as e.g. slots or physical resources, such as e.g. backhaul transmission bandwidth. This will also free up processing capacity in intermediate network nodes, and minimize the number of hops between the intermediate network nodes, which minimizes the transmission delay.

Action 207

As an alternative to Action 205 and 206, the user equipment 120 may decide to receive both the first data stream on the first receiving interface and the second data stream on the second receiving interface. This may be performed to improve the received data stream, see for example action 208.

Action 208

This action may be performed when the action 207 has been performed. The user equipment 120 may improve the received data stream by combine the first data stream received via the first receiving interface with the second data stream received via the second receiving interface. This action may be represented by performing spatial diversity.

Spatial diversity applies to analogue signals travelling over the air via different paths. By combining these different signals, better representation of the original message is provided.

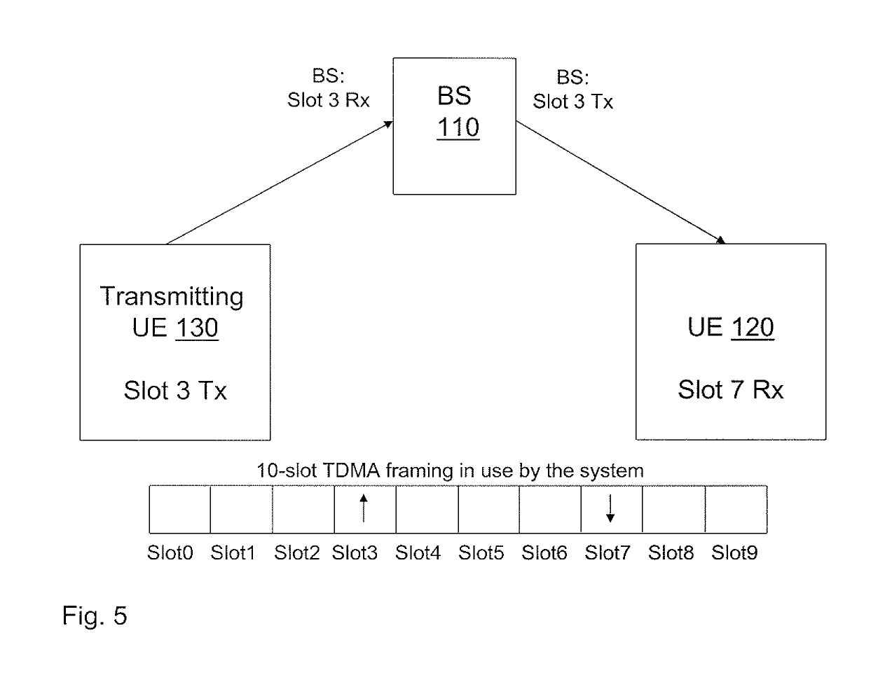

As mentioned above, some embodiments relates to a wireless TDMA-based scenario. In the following example in the wireless TDMA system, a central controller such as e.g. an access point or a base station such as the base station 110 allocates slots in a TDMA frame for end-devices such as the user equipment 120 to use for transmission and reception. A TDMA frame comprising 10 time slots in use by the wireless communication system 100 is shown in FIG. 5. FIG. 5 also depicts a simple scenario wherein the user equipment 130 transmits a data stream, also referred to as an information stream, to the user equipment 120. The data stream flows from the user equipment 130 on Slot 3 to the base station 110, referred to as BS 110 in FIG. 5, and down to the user equipment 120 on Slot 7. These slots may be assigned by the base station 110.

According to embodiments herein, the user equipment 120 will listen on both its allocated Slot 7, i.e. its first receiving interface, and all other slots, i.e. its second receiving interfaces, instead of only listen on its assigned Slot 7 and ignore all other slots in the TDMA frame. Thus, in this example the first receiving interface and the second receiving interface is of the same system, i.e. the TDMA system. A mathematical operation will be executed on the received data stream on Slot 7 and any of these other slots to create a representation of each received data stream of the respective Time Slots. As described above, a mathematical operation may be used to create the representation, which mathematical operation has the property that for any arbitrarily long string of information, a “unique” shorter representation may be created. Examples of this operation are cyclic-redundancy checks and one-way hash functions. E.g. a CRC32 may be used to compute on the respective received data stream. The operation may be performed on a per-packet basis or on parts of the packet, e.g., the payload.

By comparing the representation of Slot 7 with the representation of the respective other slots in the frame, the user equipment 120 will be able to deduce that Slot 3 also contains the identical information as that received on the primary Slot 7. It is now possible for the user equipment 120 to consider using input from both Slot 3 as well as Slot 7 to better reproduce the original transmission from the user equipment 130.

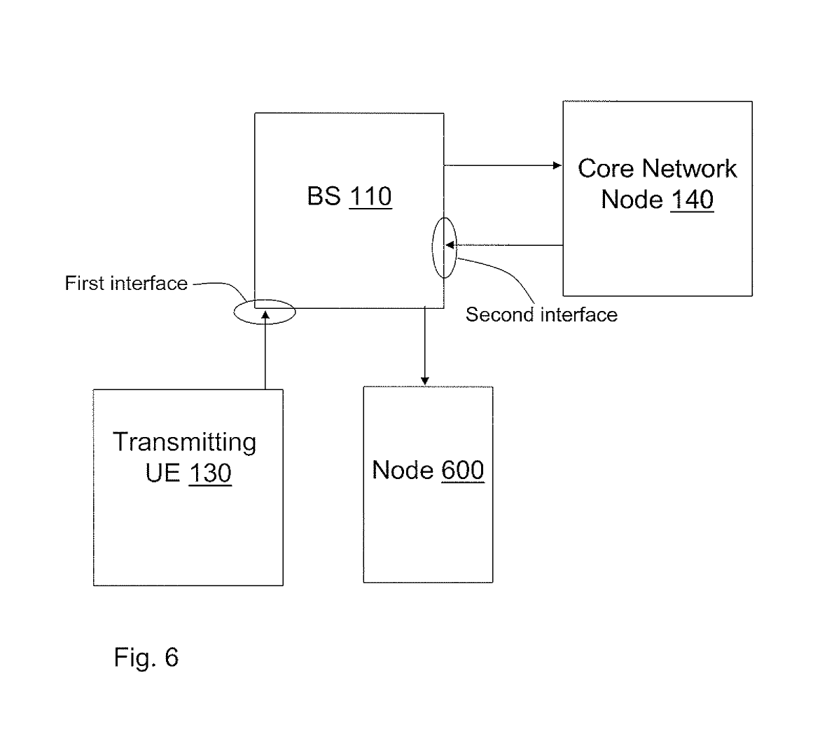

FIG. 6 shows a different scenario, wherein the method to be described below is performed in the radio network node 110, 120 when being a base station 110. However, this embodiment may be performed together with the embodiment wherein the method is performed in the user equipment 120 as described above.

FIG. 6 is a part of the wireless communications system 100 depicted in FIG. 1, and shows the base station 110, the user equipment 130, the core network node 140, and a node 600 which may be the user equipment 120. The user equipment 130 sends a data stream to the node 600, via intermediate nodes such as the base station 110 and the core network node 140. In this scenario, the base station 110 comprises a first receiving interface and a second receiving interface. The base station 110 may also comprise further receiving interfaces, even if the examples herein only describe the first receiving interface and the second receiving interface.

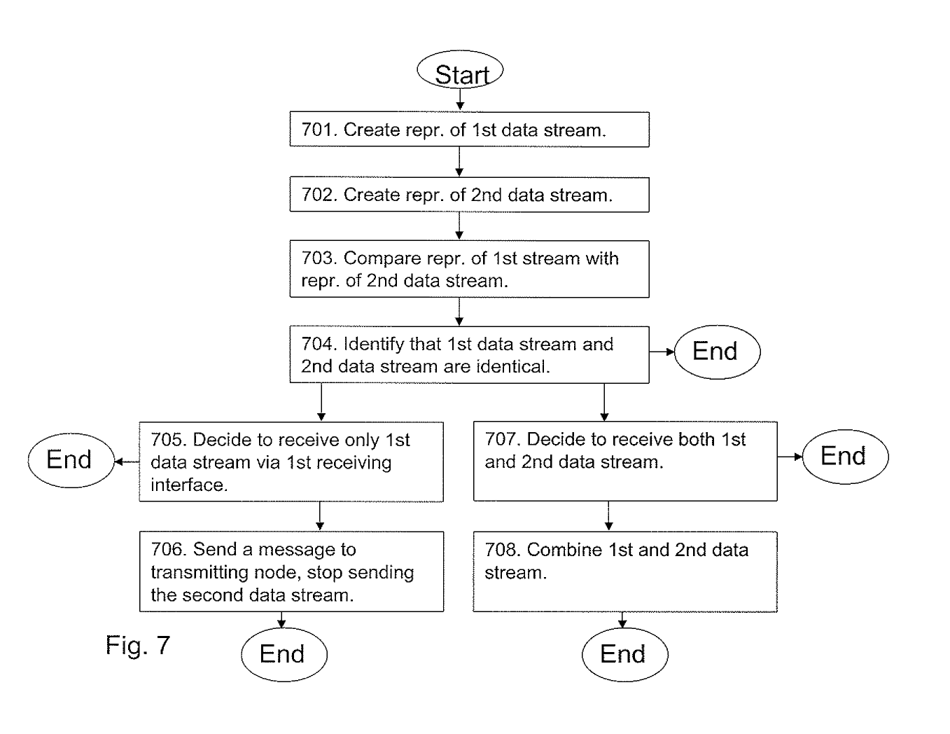

Embodiments of a method in a radio network node when being a base station 110 for handling data streams from the user equipment 130 will now be described with reference to the flowchart depicted in FIG. 7. These embodiments relates to the scenario described above with reference to FIG. 6.

Independently the base station 110 may listen to one or more other receiving interfaces also referred to as channel resources, on the same communication system and/or on one or more channels resources on one or more different communication systems.

In some embodiments the first receiving interface and the second receiving interface are interfaces of the same system. This interface may be any of the receiving interfaces of TDMA, WCDMA, LTE, Bluetooth, Wireless Local Area Network (WLAN), infrared, WiFi, device-to-device, peer-to-peer, FDMA, UMTS, HSPA of WCDMA, or GSM.

The first receiving interface may e.g. be one or more first slots in a TDMA frame, and the second receiving interface may e.g. be an allocated slot in the TDMA frame. The base station 110 then listens on both the first slot and the allocated slot.

In some embodiments, the first receiving interface is one or more first physical resource blocks in a Long Term Evolution frame /OK?, and the second receiving interface is an allocated physical resource block in a Long Term Evolution frame /OK?. The base station 110 then listens on both the one or more first physical resource block and the allocated physical resource block.

In some embodiments, the base station 110 operates with one or more communications systems. The base station 110 comprises information of, or is able to deduce, the reception parameters and algorithms that are needed to decode any packets arriving on the other channel resources it listens to.

In some embodiments the first receiving interface and the second receiving interface and possibly further receiving interfaces are interfaces of different systems. The different wireless interfaces may be any of the receiving interfaces of TDMA, WCDMA, LTE, Bluetooth, Wireless Local Area Network (WLAN), infrared, WiFi, device-to-device, peer-to-peer., FDMA, UMTS, HSPA of WCDMA, or GSM. The computations below may take place independently of whether information is arriving on the primary interface, and may comprise information directed to the base station 110 as well as information destined for other nodes. The method comprises the following actions, which actions may as well be carried out in another suitable order than described below.

Action 701

The base station 110 creates a representation of a first data stream. The data stream is received via the first receiving interface. The representation of the first data stream is in some embodiments a unique representation, and may be referred to as a compact representation of the first data stream.

This action may be performed by computing the first data stream or part of it with a mathematical operation to obtain the representation of the first data stream. The operation may be performed on a per-packet basis or on parts of the packet, e.g., the payload. The mathematical operation is such that it has a property that for any arbitrarily long string of information, a unique shorter representation is created.

The mathematical operation may e.g. be a cyclic-redundancy check, check-sums, or a one-way hash function. E.g. a 32-bit Cyclic-Redundancy Check (CRC) or 64-bit CRC, henceforth CRC32, or CRC64 may be used to compute on the received first data stream or part of it. E.g. checksums such as sum16, or sum32. One-way hash functions such as e.g., MD5, SHA-256, or similar may be used.

The identifying that the first data stream received via the first receiving interface and the second data stream received via the second receiving interface are identical data streams received via different sources of transmission to be performed in Action 204 may be improved. This may be achieved by performing the creation of the representation of the first data stream periodically, e.g. such that consecutive data packets are computed periodically. E.g. to improve on the matching estimate, a few consecutive packets of the stream may be compared, instead of just a single packet, since the mathematical function may incorrectly provide a ‘match’ outcome, even though the original packets do not match. If more then this ‘threshold value’ of consecutive packets is matched, then it may be considered that the streams identical. The higher the threshold value set at, the more certain a guess of a match will be.

In some embodiments, the one or more representations of the first data stream is stored, e.g. in a memory such as in a table in a memory.

Action 702

The base station 110 creates a representation of a second data stream. The data stream is received via the second receiving interface. The representation of the second data stream is in some embodiments a unique representation, and may be referred to as a compact representation of the second data stream.

This action may also be performed by computing at least a part of the second data stream with the mathematical operation to obtain the representation of the second data stream. As in the action above, the mathematical operation is such that it has a property that for any arbitrarily long string of information, a unique shorter representation is created. The operation may be performed on a per-packet basis or on parts of the packet, e.g., the payload. The property may e.g. be a cyclic-redundancy check, check-sums, or a one-way hash function. E.g. a 32-bit Cyclic-Redundancy Check (CRC) or 64-bit CRC, henceforth CRC32, or CRC64 may be used to compute on the received second data stream or part of it. E.g. checksums such as sum16, or sum32. One-way hash functions such as e.g., MD5, SHA-256, or similar may be used.

The identifying that the first data stream received via the first receiving interface and the second data stream received via the second receiving interface are identical data streams received via different sources of transmission to be performed in Action 204 may be improved. This may be achieved by performing the creation of the representation of the second data stream periodically, e.g. such that consecutive data packets are computed periodically. E.g. to improve on the matching estimate, a few consecutive packets of the stream may be compared, instead of just a single packet, since the mathematical function may incorrectly provide a ‘match’ outcome, even though the original packets do not match. If more then this ‘threshold value’ of consecutive packets is matched, then it may be considered that the streams identical. The higher the threshold value set at, the more certain a guess of a match will be.

In some embodiments, the one or more representation of the second data stream is also stored e.g. in a memory such as in a in the table in the memory.

Action 703

The base station 110 then compares the representation of the first data stream with the representation of the second data stream. In the embodiments wherein the representations of the data streams have been stored in the table, this action may be performed by comparing the representation of the first data stream with the contents of the table, comprising the representation of the second data stream, or the representation of the first data stream and the representation of the second data stream. In some embodiments a table whereby CRC32 values are automatically computed in hardware is provided, as information is overheard on the various receiver interfaces comprised in the base station 110. Computed CRC32 values may be stored in a table for future lookups. This is similar to the embodiment depicted in FIG. 4.

The base station 110 may use a matching scheme e.g. periodically, to compare the stored representations of the data streams. An aim of the matching scheme may be to find out if the data stream that is received the first receiving interface is also received at one or more of the other channel resources such as the second receiving interface that the user equipment listens to. The matching scheme may require that one or more consecutively received representations of the data streams match. The scheme may consider time-translated matching, i.e., checking whether a data stream has been received earlier, or possibly later, on one of the other receiving interfaces.

Action 704

When the representation of the first data stream is equal to the representation of the second data stream, the base station 110 identifies that the first data stream received via the first receiving interface and the second data stream received via the second receiving interface are identical data streams received via different sources of transmission. I.e. this enables the base station 110 to detect parallel identical packet streams, and subsequently use this information for various purposes.

In some embodiments the identifying that the first data stream and the second data stream are identical data streams received via different sources of transmission is verified when exceeding a threshold value of a number of consecutive representations of the first data stream being equal to a number of consecutive representations of the second data stream. So, e.g. as mentioned above, to improve on the matching estimate, a few consecutive packets of the stream may be compared, instead of just a single packet, since the mathematical function may incorrectly provide a match outcome, even though the original packets do not match. If more then this threshold value of consecutive packets is matched, then it may be considered that the streams identical. The higher the threshold value set at, the more certain a guess of a match will be.

Action 705

The base station 110 may decide to receive the first data stream via the first receiving interface but not the second data stream via the second receiving interface.

This may be for example be decided in a scenario where the first data stream of the first receiving interface is received from the user equipment 130 without any intermediate nodes, and where the second data stream of the second receiving interface is received from the user equipment 130 via intermediate nodes such as via the core network node 140 in FIGS. 1 and 6.

This decision may also for example be based on that the receiving of the first data stream on the first receiving interface requires less energy and/or creates less interference, and/or uses fewer system resources than the receiving of the second data stream on the second receiving interface.

Action 706

In some embodiments the base station 110 sends to the node transmitting to the second receiving interface, a message to stop transmitting the second data stream to the second receiving interface. In this embodiment the node transmitting to the second receiving interface may be the core network node 140. in this way the core network node 140 will be informed to stop the second transmission, which will off load the core network node 140 and free up resources. For the core network 140, more than a matter of freeing resources, it is rather to improve, i.e. to minimise the hop-count for the packets with a shorter route. I.e. it is a combination of freeing up resources, such as backhaul transmission bandwidth, processing capacity in intermediate network nodes, and radio resources in the radio access, and minimizing the hop-count, which minimizes the transmission delay.

Action 707

As an alternative to Action 705 and 206, the base station 110 may decide to receive both the first data stream on the first receiving interface and the second data stream on the second receiving interface.

According to any suitable embodiment herein, and as mentioned above, if the radio network node 110, 120 such as the user equipment 120 or base station 110 determines that it can receive the data stream on at least one of the other channel resources, then The network node 110, 120 may decide that it should prefer to receive the data stream on the second receiving interface instead of the first receiving interface, or vice versa. To decide that it should prefer to receive the data stream on the second receiving interface instead of the first receiving interface could be particularly beneficial if the network node 110, 120 sees that the data stream arrives earlier on the second receiving interface than on the first receiving interface, which, e.g., may happen when the transmission of the first data stream on the first receiving interface is directed to an intermediate node such as an access point, base station, relay, core network node such as the core network node 140, etc., which then forwards the first data stream to the first receiving interface of the network node 110, 120.

The network node 110, 120 may also determine that the transmission of the data stream on the second receiving interface requires less energy or that it creates less interference compared to the transmission of the data stream on the first receiving interface.

The network node 110, 120 may also decide that it should receive the data stream on both the first receiving interface and the second receiving interface, and possibly additional channel resources where the data stream is available. The network node 110, 120 may then adapt its reception parameters and algorithms for a combined reception of the data stream, which may increase reception performance based on e.g. reduced error probability, reduced susceptibility to channel variations, etc., or reduce the total energy or interference of the transmissions.

The network node 110, 120 may also use existing mechanisms in the systems to adapt the transmission of the data stream on the first receiving interface, e.g., to tell the transmitting node such as the base station 110 in some embodiments or the core network node 140 in some other embodiments, to stop transmitting or to reduce transmission power.

Embodiments herein provides the mathematical function computed on the first data stream and the second data stream, e.g., CRC32 or CRC64 to be executed in e.g. embedded in hardware. This not only makes the computation fast, but also doesn't expose the content of the information thereby protecting privacy. This is especially important for instances when one of the first or second data stream is not meant for this receiver, but destined to other nodes.

An advantage with embodiments herein is that they provide a means for nodes to detect if identical information streams are available on multiple receiving resources. A node may have access to, e.g., different interface technologies, other timeslots, frequency-bands, etc.

A further advantage with embodiments herein is that it becomes particularly useful when the wireless nodes are operating in small cells but still controlled by a central node e.g., a base station. In these scenarios the wireless nodes are more likely able to hear each other directly, and thus exploit a diversity gains brought about by the different paths the two copies of the information travels on.

A further advantage with embodiments herein is that Since the radio network node 110, 120 knows it is receiving two sources of the same transmission, it may implicitly inform the base station to reduce its transmit power, i.e., via power control, and instead, rely more on the newly-discovered source of the transmission.

A further advantage with embodiments herein relates to the transmission time.

In the example above, information is transmitted in a 2-hop manner: from the source, i.e., the user equipment 130, to the base station 110, and then from the base station 110 to the user equipment 120. If the user equipment 120 can hear the direct transmissions from the user equipment 130 then the data stream may be transmitted in a single-hop.

The benefits of the invention arise when the source and destination nodes of the data stream are close. While less evident in today's 2G and 3G systems, this may prove to more likely in future networks which may comprise of smaller cells, more devices, and more densely clustered devices.

Embodiments herein also have the advantage of operating autonomously on the radio network node 110, 120, independently of the other nodes in the system. This enables it to not only work in future networks, but to also co-exist in older systems.

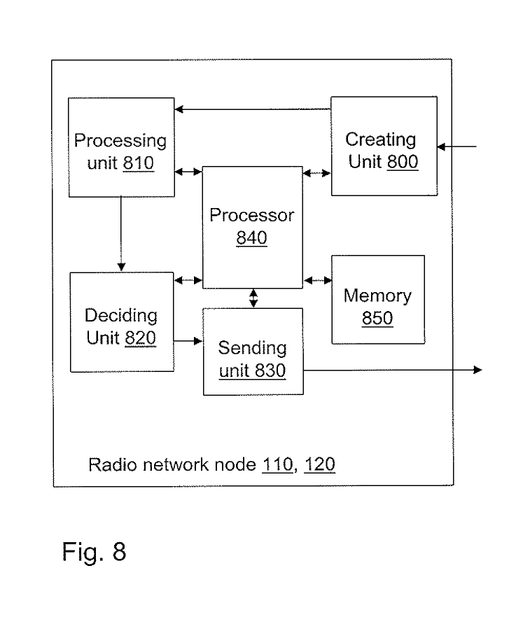

To perform the method actions in the radio network node 110, 120 described above for handling data streams from the user equipment 130, the radio network node 110, 120 comprises the following arrangement depicted in FIG. 8. As mentioned above the radio network node 110, 120 comprises the first receiving interface and the second receiving interface. The radio network node 110, 120 may e.g. be the base station 110 and/or the user equipment 120.

In some embodiments the first receiving interface and the second receiving interface are interfaces of the same system. The first receiving interface may e.g. be one or more first slots in a time division multiple access frame, and the second receiving interface may be an allocated slot in the time division multiple access frame. In these embodiments, the radio network node 110, 120 may be adapted to listen on both the one or more first slots and the allocated slot. In some embodiments the first receiving interface may be one or more first physical resource blocks in a Long Term Evolution frame, and the second receiving interface may be an allocated physical resource block in a Long Term Evolution frame. The radio network node 110, 120 may be adapted to listen on both the one or more first physical resource block and the allocated physical resource block.

In some embodiments the first receiving interface and the second receiving interface are interfaces of different systems.

The first receiving interface and the second receiving interface may be the same or different interfaces of any of: time division multiple access, wireless code division multiple access, long term evolution, Bluetooth, wireless local area network, infrared, WiFi, device-to-device, peer-to-peer, FDMA, UMTS, HSPA of WCDMA, or GSM.

The radio network node 110, 120 further comprises a creating unit 800 configured to create a representation of the first data stream, which data stream is received via the first receiving interface. The creating unit 800 is further configured to create a representation of the second data stream, which data stream is received via the second receiving interface.

The creating unit 800 may further be configured to create the representation of the first data stream is by computing the first data stream or part of it with a mathematical operation to obtain the representation of the first data stream. The operation may be performed on a per-packet basis or on parts of the packet, e.g., the payload.

The creating unit 800 may further be configured to create the representation of the second data stream is by computing at least a part of the second data stream with the mathematical operation to obtain the representation of the second data stream

In some embodiments the mathematical operation comprises a property that for any arbitrarily long string of information, a unique shorter representation is created.

The property may be represented by cyclic-redundancy check, check-sums, or a one-way hash function. E.g. a 32-bit Cyclic-Redundancy Check (CRC) or 64-bit CRC, henceforth CRC32, or CRC64 may be used to compute on the received first data stream or part of it. E.g. checksums such as sum16, or sum32. One-way hash functions such as e.g., MD5, SHA-256, or similar may be used.

In some embodiments the creating unit 800 further is configured to create the representation of the first data stream periodically for consecutive data packets of the first data stream, and create the representation of the second data stream periodically for consecutive data packets of the second data stream.

The radio network node 110, 120 further comprises a processing unit 810 configured to compare the representation of the first data stream with the representation of the second data stream.

The processing unit 810 is configured to identify that the first data stream received via the first receiving interface and the second data stream received via the second receiving interface are identical data streams received via different sources of transmission, when the representation of the first data stream is equal to the representation of the second data stream.

The processing unit 810 may further be configured to verify that the identified first data stream and second data stream are identical data streams received via different sources of transmission, when exceeding a threshold value of a number of consecutive representations of the first data stream being equal to a number of consecutive representations of the second data stream.

The radio network node 110, 120 may further comprise a deciding unit 820 configured to decide to receive the first data stream via the first receiving interface and not receive the second data stream via the second receiving interface.

In some embodiments, the first data stream of the first receiving interface is arranged to be received from the user equipment 130 without an intermediate node, and wherein the second data stream of the second receiving interface is arranged to be received from the user equipment 130 via an intermediate node, such as e.g. the base station 110, another base station serving the user equipment 130 when being located in another cell than the user equipment 120 and/or such as the core network node 140.

In some embodiments, the deciding unit 820 is further configured to decide to receive the first data stream via the first receiving interface and not receive the second data stream via the second receiving interface, based on that the receiving the first data stream on the first receiving interface requires less energy and/or creates less interference, and/or uses fewer system resources than receiving the second data stream on the second receiving interface.

In some embodiments, the deciding unit 820 is further configured to decide to receive both the first data stream on the first receiving interface and the second data stream on the second receiving interface. In these embodiments, the processing unit 810 may further be configured to combine the first data stream received via the first receiving interface with the second data stream received via the second receiving interface. The processing unit 810 may further be configured to perform spatial diversity combining.

The radio network node 110, 120 may further comprise a sending unit 830 configured to send to a node 110, 140 transmitting to the second receiving interface, a message to stop transmitting the second data stream to the second receiving interface. If the radio network node is the base station 110 the sending unit 830 may e.g. be configured to send the message to the core network node 140. If the radio network node is the user equipment, the sending unit 830 may e.g. be configured to send the message to the base station 110.

The embodiments herein for handling data streams from the user equipment 130 may be implemented through one or more processors, such as a processor 850 in the radio network node 110, 120 depicted in FIG. 8, together with computer program code for performing the functions and actions of the embodiments herein. The program code mentioned above may also be provided as a computer program product, for instance in the form of a data carrier carrying computer program code for performing the embodiments herein when being loaded into the in the radio network node 110, 120. One such carrier may be in the form of a CD ROM disc. It is however feasible with other data carriers such as a memory stick. The computer program code may furthermore be provided as pure program code on a server and downloaded to the radio network node 110, 120.

The radio network node 110, 120 may further comprise a memory 850 comprising one or more memory units. The memory 650 is arranged to be used to store data such as the one or more representations of the first data stream and the one or more representations of the second data stream, received data streams, schedulings, and applications to perform the methods herein when being executed in the radio network node 110, 120.

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention, which is defined by the appending claims,

1-34. (canceled)

35. A method in a radio network node for handling data streams from a user equipment, the method comprising:
creating a representation of a first data stream that is received via first channel resources;
creating a representation of a second data stream that is received via second channel resources;
comparing the representation of the first data stream with the representation of the second data stream, and
when the representation of the first data stream is equal to the representation of the second data stream, identifying the first and second data streams as being identical data streams received via different sources of transmission.

36. The method according to claim 35, wherein:
the creating of the representation of the first data stream is performed by computing the first data stream or part of it with a mathematical operation to obtain the representation of the first data stream;
the creating of the representation of the second data stream is performed by computing at least a part of the second data stream with the mathematical operation to obtain the representation of the second data stream; and
the mathematical operation has the property that for any arbitrarily long string of information a unique shorter representation is created.

37. The method according to claim 36, wherein the mathematical operation is a cyclic-redundancy check, a check-sum, or a one-way hash function.

38. The method according to claim 35, wherein the first and second channel resources are channel resources within the same communication system.

39. The method according to claim 38, wherein the first channel resources are one or more first slots in a time division multiple access frame, and wherein the second channel resources are an allocated slot in a time division multiple access frame, and wherein the radio network node listens on both the one or more first slots and the allocated slot.

40. The method according to claim 38, wherein the first channel resources are one or more first physical resource blocks in a Long Term Evolution frame, and wherein the second channel resources are an allocated physical resource block in a Long Term Evolution frame, and wherein the radio network node listens on both the one or more first physical resource blocks and the allocated physical resource block.

41. The method according to claims 35, wherein the first and second channel resources are channel resources in different communication systems.

42. The method according to claim 41, wherein the first and second channel resources comprise any of: time division multiple access channel resources, wireless code division multiple access channel resources, long term evolution channel resources, Bluetooth channel resources, wireless local area network channel resources, infrared channel resources, WiFi channel resources, device-to-device channel resources, peer-to-peer channel resources, frequency division multiple access channel resources, universal mobile telecommunications system channel resources, high speed packet access of wideband code division multiple access channel resources, or global system for mobile communications channel resources.

43. The method according to any of the claims 35, further comprising, at least for the case where the first and second data streams are identified as being identical data streams received via different sources of transmission, deciding to receive the first data stream via the first channel resources and not to receive the second data stream via the second channel resources.

44. The method according to claim 43, wherein the first data stream is received from the user equipment without an intermediate node, and wherein the second data stream is received from the user equipment via an intermediate node.

45. The method according to claim 43, further comprising sending to a node that is transmitting the second data stream via the second channel resources, a message to stop transmitting the second data stream via the second channel resources.

46. The method according to claim 43, wherein the deciding to receive the first data stream via the first channel resources and not to receive the second data stream via the second channel resources is based on receipt of the first data stream via the first channel resources requiring less energy, creating less interference, or using fewer system resources, as compared to receipt of the second data stream via the second channel resources.

47. The method according to claim 35, further comprising, at least for the case where the first and second data streams are identified as being identical data streams from different transmission sources:
deciding to receive both the first and second data streams; and
combining the first and second data streams.

48. The method according to claim 47, wherein the combining comprises spatial diversity combining.

49. The method according to claim 35, wherein the creating of the representation of the first data stream is performed periodically for consecutive data packets of the first data stream, and wherein the creating of the representation of the second data stream is performed periodically for consecutive data packets of the second data stream.

50. The method according to claim 49, wherein identifying the first and second data streams as being identical data streams from different transmission sources comprises verifying that there is a least a threshold number of consecutive representations of the first data stream that are equal to corresponding consecutive representations of the second data stream.

51. The method according to claim 35, wherein the radio network node is a base station or a user equipment.

52. A radio network node for handling data streams from a user equipment, the radio network node comprising:
a receiver configured to receive a first data stream via first channel resources and a second data stream via second channel resources; and
one or more processors configured to:
create a representation of the first data stream and further configured to create a representation of the second data stream, which second data stream is received via the second channel resources;
compare the representation of the first data stream with the representation of the second data stream; and
identify that the first and second data streams are identical data streams received via different sources of transmission, when the representation of the first data stream is equal to the representation of the second data stream.

53. The radio network node according to claim 52, wherein the one or more processors are configured to create the representation of the first data stream via a mathematical operation applied to all or part of the first data stream, and to create the representation of the second data stream via the mathematical operation applied to all or part of the second data stream, and wherein the mathematical operation comprises a property that for any arbitrarily long string of information, a unique shorter representation is created.

54. The radio network node according to claim 53, wherein the mathematical operation is a cyclic-redundancy check, a check-sum, or a one-way hash function.

55. The radio network node according to claim 52, wherein the first channel resources and the second channel resources are channel resources within the same communication system.

56. The radio network node according to claim 55, wherein the first channel resources are one or more first slots in a time division multiple access frame, and wherein the second channel resources are an allocated slot in the time division multiple access frame, and wherein the radio network node is adapted to listen on both the first slot and the allocated slot.

57. The radio network node according to claim 56, wherein the first channel resources are one or more first physical resource blocks in a Long Term Evolution frame, and wherein the second channel resources are an allocated physical resource block in a Long Term Evolution frame, and wherein the radio network node is adapted to listen on both the first physical resource block and the allocated physical resource block.

58. The radio network node according to claim 52, wherein the first channel resources and the second channel resources are in different communication systems.

59. The radio network node according to claim 52, wherein the first and second channel resources comprise any of: time division multiple access channel resources, wireless code division multiple access channel resources, long term evolution channel resources, Bluetooth channel resources, wireless local area network channel resources, infrared channel resources, WiFi channel resources, device-to-device channel resources, peer-to-peer channel resources, frequency division multiple access channel resources, universal mobile telecommunications system channel resources, high speed packet access of wideband code division multiple access channel resources, or global system for mobile communications channel resources.

60. The radio network node according to claim 52, wherein, at least for the case where the first and second data streams are identified as being identical data streams from different transmission sources, the one or more processors are configured to decide to receive the first data stream via the first channel resources and not to receive the second data stream via the second channel resources.

61. The radio network node according to claim 60, wherein the first data stream is received from the user equipment without an intermediate node, and wherein the second data stream is received from the user equipment via an intermediate node.

62. The radio network node according to claim 60, wherein the one or more processors are configured to send to a node that is transmitting the second data stream via the second channel resources, a message to stop transmitting the second data stream via the second channel resources.

63. The radio network node according to claim 60, wherein, at least for the case where the first and second data streams are identified as being identical data streams from different transmission sources, the one or more processors are configured to decide to receive the first data stream and not to receive the second data stream, based on receipt of the first data stream on the first channel resources requiring less energy, creating less interference, or using fewer system resources, as compared to receipt of the second data stream on the second channel resources.

64. The radio network node according to claim 52, wherein, at least for the case where the first and second data streams are identified as being identical data streams from different transmission sources, the one or more processors are configured to decide to receive both the first and second data streams, and to combine the first and second data streams.

65. The radio network node according to claim 64, wherein the one or more processors are configured to perform spatial diversity combining of the first and second data streams.

66. The radio network node according to claim 52, wherein the one or more processors are configured to create the representation of the first data stream periodically for consecutive data packets of the first data stream, and to create the representation of the second data stream periodically for consecutive data packets of the second data stream.

67. The radio network node according to claim 66, wherein the one or more processors are configured to identify that the first and second data streams are identical data streams from different transmission sources by verifying that there is a least a threshold number of consecutive representations of the first data stream that are equal to corresponding consecutive representations of the second data stream.

68. The radio network node according to claim 52, wherein the radio network node is a base station or a user equipment.
